(19) United States
(12) Patent Application Publication
(10) Pub. No.: US 2024/0165859 A1
(43) Pub. Date: May 23, 2024

(54) MANUFACTURE OF A TIMEPIECE COMPONENT

(71) Applicant: ROLEX SA, Geneva (CH)

(72) Inventors: Benjamin Celant, Geneva (CH); Philippe Di Piazza, Geneva (CH)

(73) Assignee: ROLEX SA, Geneva (CH)

(21) Appl. No.: 18/510,259

(22) Filed: Nov. 15, 2023

(30) Foreign Application Priority Data
Nov. 17, 2022 (EP) 22207941.0

(51) Int. Cl. B29C 43/18

(52) U.S. Cl. CPC B29C 43/18; B29L 2031/7276

(57) ABSTRACT

The process for manufacturing a timepiece component (10) including at least one fastening element (12), includes positioning at least one fastening element (12) within a manufacturing mould (20) by means of at least one guide element (25; 35), filling the manufacturing mould (20) with a material so as to overmould, i.e. at least partially envelop and set, the at least one fastening element (12) in the material, and removing the timepiece component (10) from the manufacturing mould (20), this timepiece component (10) being at least partly formed by the material and the at least one fastening element (12).

### CROSS-REFERENCE TO RELATED APPLICATION

This application claims priority of European patent application No. EP22207491.0 filed Nov. 17, 2022, the content of which is hereby incorporated by reference herein in its entirety.

### INTRODUCTION

The present invention relates to a process for manufacturing a timepiece component. The invention also relates to a timepiece component per se, and also to a timepiece comprising such a timepiece component.

### BACKGROUND ART

In the field of watch- or clock-making, it is sometimes desirable to add ornamental elements to a component, for example to a bracelet strand. More generally, it may be desired to add various elements and/or functionalities to a particular component.

To produce such an addition, it is necessary to achieve all or some of the following objectives:
a satisfactory result in terms of aesthetics and comfort when worn;
a result with satisfactory mechanical properties;
a reliable and robust result;
a result that is easy to obtain, in a repeatable manner.

Thus, the general aim of the present invention is to propose a solution for manufacturing a timepiece component comprising at least one complementary element and/or one additional functionality, while at the same time having an aesthetically attractive result, with satisfactory mechanical properties, which is reliable and robust, and easy to obtain, and in a repeatable manner.

### SUMMARY OF THE INVENTION

To this end, the invention is based on a process for manufacturing a timepiece component comprising at least one fastening element, wherein it comprises the following steps:
positioning at least one fastening element within a manufacturing mould by means of at least one guide element;
filling the manufacturing mould with a material so as to overmould, i.e. at least partially envelop and set, the at least one fastening element in the material;
removing the timepiece component from the manufacturing mould, this timepiece component (10) being at least partly formed by said material and the at least one fastening element.

The invention also relates to a timepiece component, in particular a bracelet strand, comprising at least one fastening element, wherein the timepiece component is based on an overmoulded material at least partially enveloping and setting said at least one fastening element within the timepiece component.

The invention is more precisely defined by the claims.

### BRIEF DESCRIPTION OF THE DRAWINGS

These objects, features and advantages of the present invention will be presented in detail in the following description of particular embodiments given on a non-limiting basis in relation to the accompanying figures, in which:

FIG. 1 represents a first cross-sectional view of a mould for manufacturing a bracelet strand according to an embodiment of the invention.

FIG. 2 represents a second cross-sectional view of the mould for manufacturing a bracelet strand according to the embodiment of the invention.

FIGS. 3 to 6 represent schematic cross-sectional views of steps of a process for manufacturing a bracelet strand according to a first embodiment of the invention.

FIG. 7 represents a partial cross-sectional view of a bracelet strand according to a first implementation variant obtained via the process according to the first embodiment of the invention.

FIG. 8 represents an enlarged partial cross-sectional view of a bracelet strand according to a second implementation variant obtained via the process according to the first embodiment of the invention.

FIGS. 9 to 10 represent schematic cross-sectional views of steps in the manufacturing process according to the first embodiment of the invention for obtaining the bracelet strand according to the second implementation variant.

FIGS. 11 to 13 represent schematic cross-sectional views of steps of a process for manufacturing a bracelet strand according to a second embodiment of the invention.

FIG. 14 represents an enlarged partial cross-sectional view of a bracelet strand according to a first implementation variant obtained via the process according to the second embodiment of the invention.

FIG. 15 represents an enlarged partial cross-sectional view of a bracelet strand according to a second implementation variant obtained via the process according to the second embodiment of the invention.

FIGS. 16 and 17 represent schematic cross-sectional views of steps of a process for manufacturing a bracelet strand according to a third embodiment of the invention.

FIG. 18 represents an enlarged partial cross-sectional view of a bracelet strand according to a first implementation variant obtained via the process according to the third embodiment of the invention.

### DETAILED DESCRIPTION OF PARTICULAR EMBODIMENTS

Throughout the text hereinbelow, the adjectives “upper” and “lower” will be used to refer to the future positioning of the timepiece component. For example, in the case of a bracelet strand, the adjective “lower” denotes the orientation intended to be on the wrist side of a wearer and the adjective “upper” denotes the opposite orientation.

The invention will be described, by way of example, in the specific case of manufacturing a bracelet strand. As a variant, it may also be used for manufacturing another timepiece component.

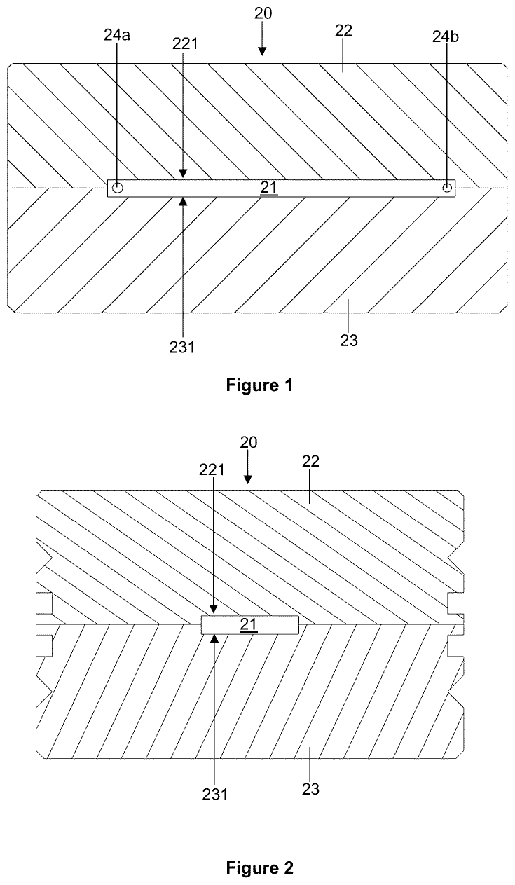

FIGS. 1 and 2 represent a mould 20 used for performing the invention. Such a mould 20 comprises a cavity 21 delimited by two half-moulds 22, 23 which are movable relative to each other. These two half-moulds 22, 23 respectively comprise walls 221, 231 which form a delimitation of the cavity 21 of the mould 20, respectively the upper and lower planes of this cavity 21. FIGS. 1 and 2 more precisely represent cross-sections of the mould 20 at the level of cavity 21, respectively along two perpendicular median planes. The cavity 21 has a substantially flat and rectangular shape, which corresponds to the shape of the bracelet strand to be manufactured, and said two cutting planes in FIGS. 1 and 2 are median planes, respectively longitudinal, i.e. oriented along the length of the cavity 21, perpendicular to a plane formed by a wall 221, 231 of this cavity, and transverse, i.e. oriented perpendicular to the longitudinal direction of the cavity 21, perpendicular to a plane formed by a wall 221, 231 of this cavity.

The two half-moulds 22, 23 respectively comprise the walls 221, 231 which are substantially flat and parallel in FIGS. 1 and 2. Alternatively, these walls 221, 231 may be curved. Their shape corresponds to the shape of the upper and lower surfaces of the bracelet strand to be manufactured. Optional housing portions 24a, 24b are positioned within the mould cavity 21. Their function will be specified later.

The concept of the invention consists in positioning a fastening element within such a manufacturing mould, before filling the manufacturing mould with a material, so as to overmould the fastening element, i.e. to envelop it at least partially in said material, in a manner sufficient to set it in the material. This material corresponds to the main material of the bracelet strand and/or to the material that is visible from the upper surface and/or the lower surface of the bracelet strand, and will be referred to hereinbelow as the “material of the bracelet strand” or more simply as the “material”.

The mould may be filled by any means, notably by injection or compression moulding. In the case of an injection moulding process, the material is, for example, injected at a given pressure (typically between 80 bar and 150 bar, or even between 80 bar and 90 bar) into the cavity 21, while the mould is already closed and has a given temperature (typically between 150° C. and 250° C., or even between 150° C. and 200° ° C.). In the case of a compression moulding process, a preform or blank of strand material is positioned on the wall 231 before the mould is closed, and is then compressed at a given temperature (typically between 150° C. and 250° C., or even between 150° C. and 200° C.). In all cases, this material is positioned at least partly around one or more fastening elements, so as to envelop them and set them in the bracelet strand: this material thus overmoulds the fastening element(s).

Advantageously, the material is an elastomer or elastomer-based material, i.e. a material comprising at least 50% by weight of elastomer. In particular, the elastomer material may be a fluoro elastomer (FKM, FFKM or FEPM), or a natural rubber (NR) or synthetic rubber (SBR, HNBR, EPDM), or a vinyl methyl silicone (VMQ) or a fluoro silicone (FVMQ). More generally, the component material may be a polymer. It may notably be a thermoplastic or thermosetting polymer.

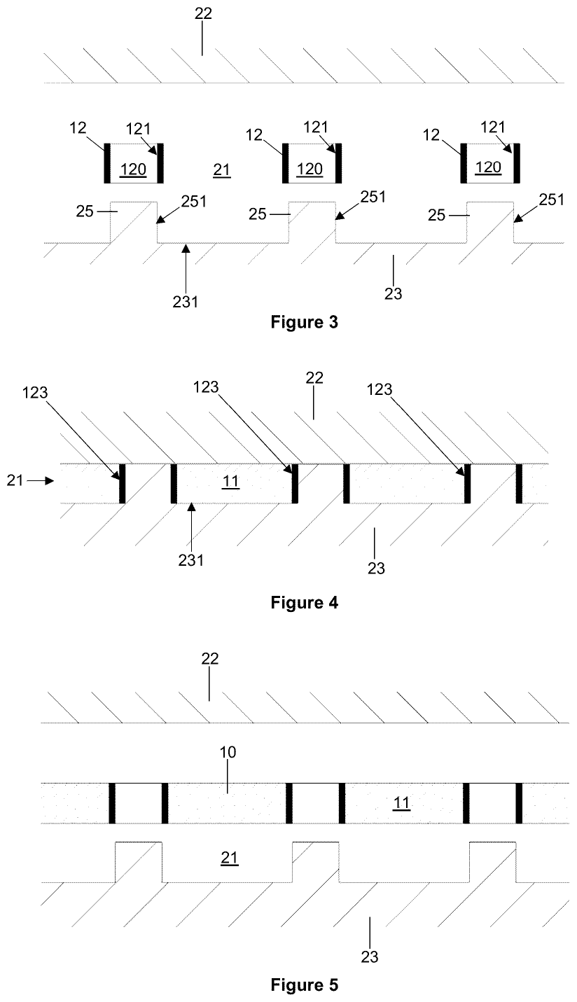

A first embodiment of a process for manufacturing a bracelet strand will now be detailed with reference to FIGS. 3 to 6.

FIG. 3 illustrates a first step in the process according to the first mode, which consists in positioning at least one fastening element 12 within the manufacturing mould 20 by means of at least one guide element 25. In the example shown, three fastening elements 12 are positioned, each by means of a guide element 25. There are thus as many guide elements 25 as there are fastening elements 12.

In this first embodiment, each guide element 25 is a projecting element, fixed or integrally formed on a half-mould 23 of the mould 20, preferably on a fixed half-mould 23 of the mould 20.

For example, at least one guide element 25 may be machined, notably manufactured by electroerosion directly on the half-mould 23. Alternatively, at least one guide element 25 may be manufactured on an auxiliary plate, which is then fixed to the half-mould 23. Alternatively also, at least one guide element may be included, notably by driving, within an aperture formed on the half-mould 23.

In this first embodiment, each guide element 25 is in the form of a cylindrical stud which projects from the wall 231 of the lower half-mould 23, thus extending into the cavity 21 of the mould 20. The contour of the stud at least partially forms a first guide surface 251, which is intended to cooperate with a second guide surface 121, formed on the fastening element 12.

The fastening element 12 is itself in the form of a ring with an aperture 120 which is intended to receive the stud. The inner surface of the ring, delimiting the aperture 120, forms the second guide surface 121. In this embodiment, each fastening element 12 extends substantially over the entire height of the cavity 21 of the mould 20 (apart from the assembly clearance).

The process then comprises a second step, represented by FIG. 4, which consists in filling the manufacturing mould 20 with a material 11 so as to overmould the at least one fastening element 12 in the material 11.

Advantageously, in this second step, the guide element 25 blocks any entry of material or considerably limits the entry of material into the aperture 120 of the fastening element 12. The outer contour of the fastening element 12, for its part, forms at least one binding surface 123 intended to come into contact with the material 11 injected or compressed around it.

The process then comprises a third step, represented by FIG. 5, which consists in removing the timepiece component 10, i.e. the bracelet strand, from the manufacturing mould 20. This timepiece component 10 is thus at least partly formed by the material 11 which has filled the cavity 21 of the mould 20 and the at least one fastening element 12, notably the three fastening elements 12 according to the example illustrated. In this demoulding step, the upper half-mould 22 is separated from the lower half-mould 23, which is fixed according to this implementation example. It should be noted that the result obtained during the demoulding step may only be a rough outline of the bracelet strand, which still requires finishing operations, such as cutting, surface treatment, etc., before obtaining the finished bracelet strand.

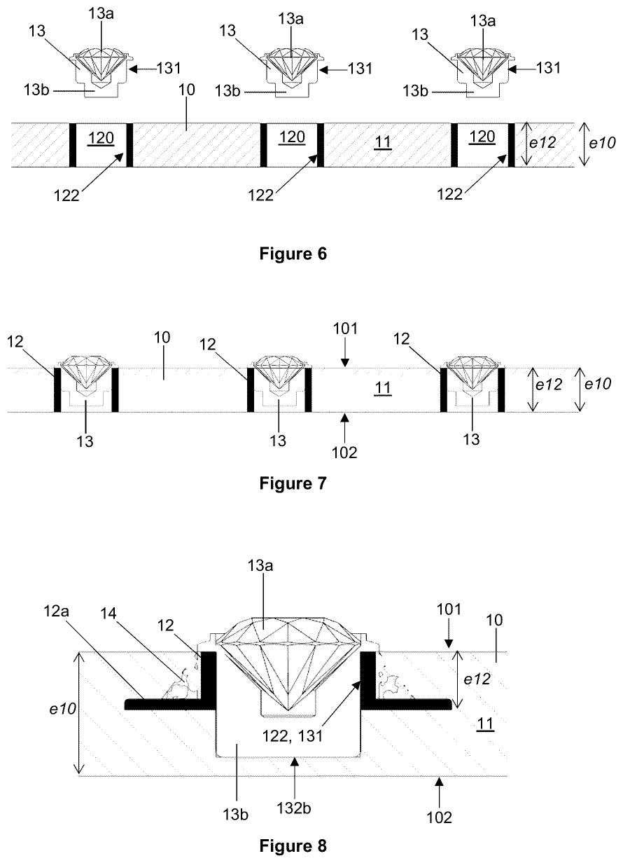

In this first embodiment, each fastening element 12 is a ring comprising an aperture 120, which is intended to receive an ornamental element 13. In particular, the contour of the aperture 120 at least partially forms a second receiving surface 122, which is intended to cooperate with a first receiving surface 131 of an ornamental element 13. The process thus comprises a fourth step of setting an ornamental element 13 into at least one fastening element 12, as represented by FIG. 6. These first and second receiving surfaces 122, 131 are, for example, guide and/or driving surfaces. It should be noted that the second receiving surface 122 of the fastening element 12 is merged here with the abovementioned second guide surface 121. Beforehand, any undesired overspilling material 11, notably within the aperture 120, which may result from the second filling step, may be removed via a technique known to those skilled in the art, for instance cryogenic sandblasting.

FIG. 7 thus illustrates a partial cross-sectional view of a first variant of a bracelet strand obtained via the first embodiment of the manufacturing process described previously.

According to this first variant, the manufactured timepiece component 10, i.e. the bracelet strand, comprises three fastening elements 12, in the form of rings, each receiving an ornamental element 13. Each of the fastening elements 12 is in the form of a straight cylinder, the height e12 of which corresponds or substantially corresponds to the thickness e10 of the bracelet strand, defined by the material 11 outside the fastening elements 12. This material 11 is overmoulded or compressed around the fastening elements 12, notably on the binding surfaces 123 of the fastening elements 12. It should be noted that, according to this embodiment, the height of the guide elements 25 corresponds substantially to that of the fastening elements 12, and to that of the cavity 21, which itself corresponds to the thickness of the bracelet strand. The fastening elements 12 thus define apertures 120 passing through the thickness of the bracelet strand.

In order to promote the binding of the material 11 around the fastening elements 12, their binding surfaces 123 may be textured via a technique known to those skilled in the art, so as to make them particularly rough. Alternatively or additionally, these surfaces may be coated with a binding primer. According to this first variant, the binding surface 123 of a fastening element 12 forms the entire outer peripheral surface of the cylindrical ring forming the fastening element 12.

Moreover, according to this first variant, the ornamental elements 13 each comprise a chaton 13b within which is set a stone 13a that is visible from the upper surface 101 of the bracelet strand. Each chaton 13b is accessible here to allow, if necessary, disengagement of the ornamental element 13 from the lower surface 102 of the bracelet strand.

FIG. 8 shows an enlarged partial view of a bracelet strand according to a second variant obtained according to the first embodiment of the process. This second variant seeks to maximize the binding of the material 11 to a fastening element 12 while at the same time locally limiting the bending of a bracelet strand.

Advantageously, the fastening element 12 comprises here a first upper cylindrical portion, always defining a central aperture, terminating at its base in a disc or a second cylindrical portion arranged around the first cylindrical portion, which defines a seating 12a. The fastening element 12 is thus here a seating ring. Furthermore, in this second particular variant, the height e12 of the fastening element 12 is strictly less than the thickness e10 of the bracelet strand. The seating 12a of the fastening element 12 is thus embedded in the material 11 of the bracelet strand, i.e. in the thickness of the bracelet strand, since the material 11 extends on either side of the upper and lower surfaces of said seating 12a. This second embodiment variant allows the bending of the bracelet strand to be minimized locally, around the peripheral surface of the fastening element 12, notably around the first cylindrical portion of the fastening element 12, in particular at the seating 12a formed by the disc or the second cylindrical portion of the fastening element 12.

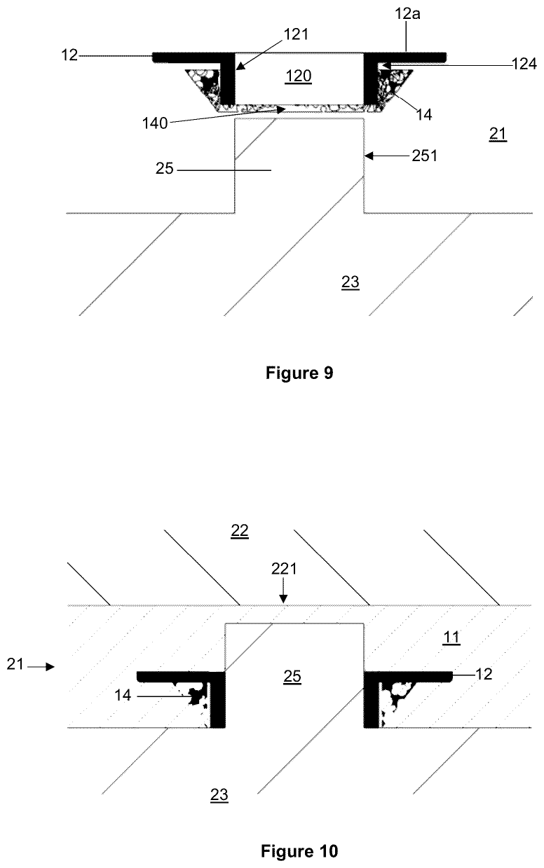

Optionally, in addition, a hooking element 14 may be associated with the fastening element 12. In this second implementation variant, this hooking element is in the form of a ring with an aperture 140, the diameter of which is intended for positioning around the fastening element, according to a step of the process according to the first embodiment more particularly represented by FIG. 9. Furthermore, this hooking element 14 advantageously comprises a honeycomb structure so that the material 11 of the bracelet strand can be inserted and anchored within this hooking element 14, and also between the fastening element 12 and the hooking element 14. The term “honeycomb structure” means a structure comprising a multitude of intersecting through apertures. Advantageously, the hooking element 14 may be in the form of a metal foam. Preferentially, the hooking element 14 is conical or frustoconical in shape, with its volume increasing towards the interior of the thickness of the bracelet strand, i.e. in a direction going from the upper surface towards the lower surface of the bracelet strand. The advantage of such a shape is that it minimizes the visibility of the hooking element 14 from the upper surface of the bracelet strand. Moreover, such a progressive shape enables the material 11 to bind better. Such a geometry of the fastening element 12, combined with such a hooking element 14, allows the phenomenon of yawning around the fastening element 12 to be very substantially minimized, or even eliminated, i.e. deformation of the aperture of the strand around the fastening element 12 allowing an undesirable gap to appear. It should be noted that, as a variant, such a hooking element 14 may be combined with all the fastening elements of any implementation variant according to the invention. It remains optional in all cases.

In addition, the height of the guide element 25 associated with the fastening element 12 during the process for obtaining a bracelet strand according to the second variant is here strictly less than that of the cavity 21, as will be described hereinbelow. Thus, the aperture 120 of the fastening element does not form a through aperture in the thickness of the bracelet strand, but a blind aperture. As a result, the decorative element 13 set into the fastening element 12, as described in relation to the first implementation variant, is not visible from the lower surface 102 of the bracelet strand. Nevertheless, the conformation of the ornamental element 13, in particular of the chaton 13b, may be provided so that it can be actuated from this lower surface 102. For example, the chaton 13b may comprise an actuating surface 132b projecting from the fastening element 12, i.e. extending deeper into the thickness of the bracelet strand than the fastening element 12, so as to present a lower surface extending parallel or substantially parallel to the lower surface 102 of the bracelet strand, and in the vicinity of this lower surface. Such a surface may, for example, cooperate with dedicated tooling so as to allow disengagement of the ornamental element. Alternatively, the ornamental element 13, in particular the chaton 13b, may be shaped so that it cannot be actuated once it has been assembled within the fastening element 12. By way of example, the chaton 13b may be embedded within the fastening element 12, as will be illustrated with reference to FIG. 18 hereinbelow.

FIGS. 9 and 10 illustrate steps of the manufacturing process according to the first embodiment for obtaining a bracelet strand according to the second implementation variant.

The first step of the process comprises, in addition to the process described in relation to the first variant, the positioning of a hooking element 14 around a fastening element 12, before or during the positioning of the latter around a guide element 25, as represented by FIG. 9. To this end, the first cylindrical portion of the fastening element 12 comprises a surface 124 for receiving the hooking element 14 at its outer periphery. Thus, the fastening element 12 is inserted within the central aperture 140 of the hooking element 14; this assembly may then be positioned within the cavity 21 of the mould 20 by means of a guide element 25, notably by the cooperation of the guide surfaces 121 and 251 as described with reference to the manufacture in the first implementation variant. It should be noted that, according to this representation, the half-mould 23 forms the upper half-mould of the mould, i.e. the half intended to form the upper surface of the bracelet strand.

FIG. 10 illustrates the second step of filling the mould with a material 11 forming the envelope of the bracelet strand. As mentioned previously, the guide element 25 does not extend over the entire height of the cavity 21, and so material 11 also extends between the distal end of the guide element 25 and the wall 221 of the cavity 21 of the mould 20, which forms the lower surface of the bracelet strand.

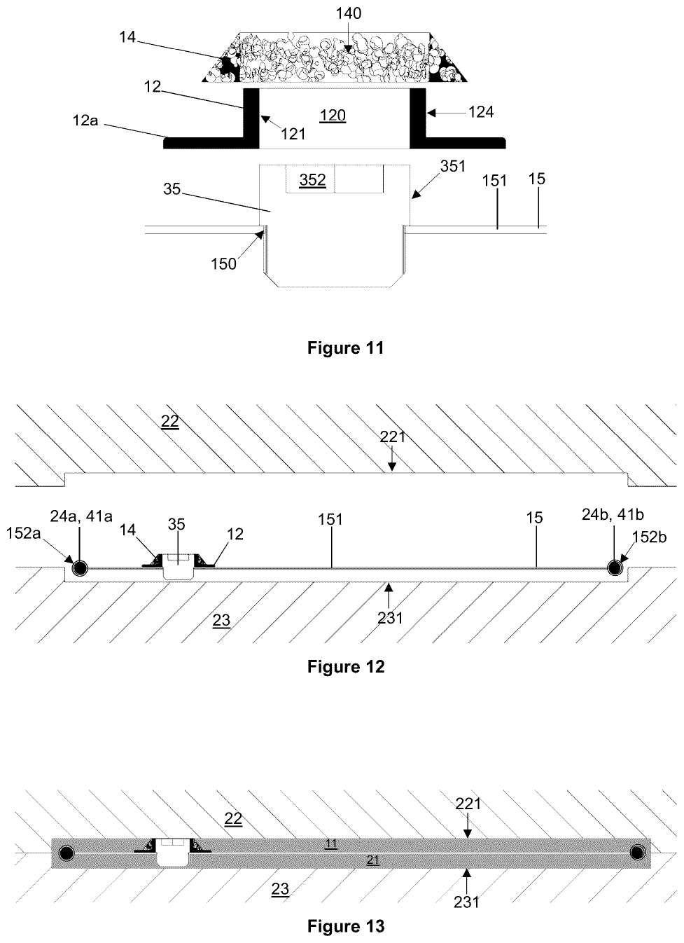

FIGS. 11 to 13 illustrate a process for manufacturing a bracelet strand according to a second embodiment of the invention.

This second embodiment differs from the first in that it uses an insert 15 constituting the bracelet strand to be manufactured. Moreover, according to this embodiment, the at least one fastening element 12 is positioned within the mould cavity 21 by means of a guide element 35 previously positioned on such an insert 15 constituting the bracelet strand to be manufactured.

Thus, as is seen in FIGS. 11 and 12, an insert 15 according to a particular embodiment is in the form of a blade 151, which may advantageously be a metal blade 151, in particular a superelastic metal alloy blade 151. This blade comprises two loops 152a, 152b arranged, respectively, at each of its longitudinal ends. This insert 15 also serves as a support for the guide element(s) 35 provided for positioning the fastening element(s) 12.

As is seen in FIG. 11, a guide element 35 may be in the form of a screw screwed into a through aperture 150 in the blade 151. The periphery of the screw head constitutes here a first guide surface 351, intended to cooperate with a second guide surface 121 arranged on the fastening element 12. As in the abovementioned examples detailing the first embodiment, the fastening element 12 is in the form of a ring provided with an aperture 120 at least partially forming the second guide surface 121.

As shown in FIG. 11, the fastening element 12 corresponds substantially to that of the second variant of bracelet strand obtained via the process according to the first embodiment, and is associated in the same manner with a hooking element 14, this assembly then being mounted on a guide element 35, once the latter has been positioned on an insert 15, outside or in the cavity 21 of a mould 20, identical to the mould 20 used within the process according to the first embodiment, as shown in FIG. 12.

The material 11 then fills the volume of the cavity 21, as represented by FIG. 13, thus overmoulding the assembly comprising the insert 15, so as to set it into the material 11 and thus in the resulting bracelet strand.

The manufacturing process according to this second embodiment thus comprises the steps of the first embodiment and differs in that it comprises the steps specified below.

The first step of the process comprises a preliminary sub-step which consists in assembling at least one guide element 35 on an insert 15. This assembling may be performed by any means, other than the screwing described previously. Thus, the guide element 35 may, as a variant, be different from a screw as represented. It should be noted that this preliminary step may also comprise mounting a hooking element 14 around the fastening element 12.

The first step of positioning at least one fastening element 12 in the manufacturing mould is thus obtained by means of this guide element 35, and by means of an insert 15, which is itself preferentially positioned within the manufacturing mould.

The first step thus comprises, for example, positioning the insert 15 on the half-mould 23 of the mould. To do this, pins 41a, 41b are provided for threading, respectively, firstly into loops 152a, 152b of the insert 15, in particular the blade 151, and secondly into portions of housings 24a, 24b formed on the half-mould 23 of the mould. Thus, the blade 151 is positioned within the cavity 21, and is kept suspended at a distance from the opposite longitudinal walls 221, 231 of the mould 20 once the mould is closed.

After removing the bracelet strand from the mould, the process comprises an intermediate step which consists in removing the at least one guide element from the bracelet strand blank, notably by unscrewing according to the example illustrated. Next, an ornamental element 13 may, for example, be set within the aperture 120 of at least one fastening element 12, notably by engagement, as described with reference to the first embodiment.

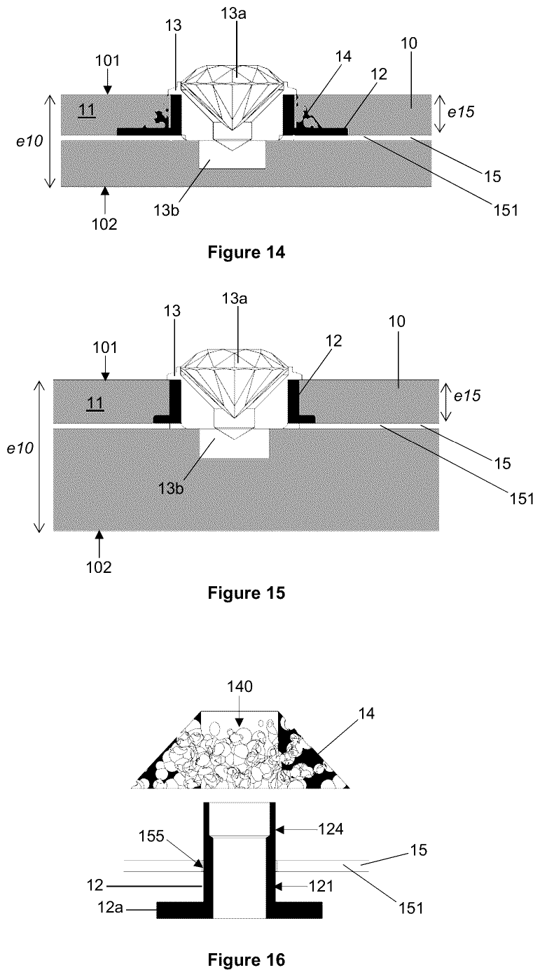

FIG. 14 thus illustrates a first variant of a bracelet strand obtained via the process according to the second embodiment. The blade 151 forming the insert 15 is positioned at the centre of the thickness e10 of the bracelet strand. In other words, the blade 151 is equidistant or substantially equidistant from the upper surface 101 and the lower surface 102 of the bracelet strand, with a distance e15 separating it from the upper surface 101 equal or substantially equal to e10/2. Thus, the blade 151 constitutes or comes close to the ply of neutral fibres of the bracelet strand when the latter is subjected to simple bending. Moreover, it should be noted that this blade 151 thus acts as a reinforcement for the bracelet strand.

FIG. 15 illustrates a second variant of the bracelet strand obtained via the process according to this second embodiment. The bracelet strand differs from that according to the first variant in that the blade 151 is positioned closer to the upper surface 101 of the bracelet strand, so as to shift the ply of neutral fibres towards this upper surface 101. This is in fact made possible by the fact that the material of the blade 151 is advantageously stiffer than the material of the timepiece component, in particular of the bracelet strand, namely the material at least partially enveloping at least one fastening element. Thus, in this design, the thicknesses comply with the following conditions: e15<e10/2, or even e15<e10/3. To obtain the bracelet strand according to this second implementation variant, the positions of the housings 24a, 24b within the cavity 21 of the mould may be shifted so as to bring the blade 151 closer to a longitudinal wall of a half-mould of the mould 20, during the first step of the process. This second implementation variant has the advantage of minimizing traction phenomena around the fastening element 12 when the bracelet strand is bent. Specifically, tests have shown that this design allows any yawning around the fastening element 12 to be substantially limited, or even prevented, without the need to insert a hooking element 14. It is also possible to minimize the size, in particular the diameter, of the seating 12a, or even to dispense with the seating 12a of the fastening element 12. Such a design according to this second implementation variant thus also has the advantage of limiting the bulk of the elements required for fastening an ornamental element 13 to the bracelet strand, on the one hand by dispensing with the hooking element 14, and on the other hand by minimizing the size of the fastening element 12. The advantage of such a design is thus that it allows different ornamental elements to be brought closer together, and their number on the bracelet strand can thus possibly be maximized, for example for aesthetic purposes.

In these embodiments, the resulting fastening element 12 rests on the insert 15.

The process according to the third embodiment constitutes an alternative to the second embodiment. The at least one fastening element 12 is positioned here on the insert 15 not by a guide element 35 previously positioned on the blade 151, but directly within an aperture 155 formed on the blade acting as guide element 35, as represented by FIG. 16. To this end, the at least one fastening element 12 comprises a guide surface 121 intended to cooperate with the contour of the aperture 155, which thus forms a guide element 35. In particular, the at least one fastening element 12 is in the form of a ring whose outer periphery comprises the guide surface 121 which is intended to be housed in the aperture 155. In order to allow the ring to be held on the blade 151, the outer periphery of the ring also comprises a surface 124 for receiving, notably for engaging, a hooking element 14 in the form of a ring. In addition, the fastening element 12 also comprises a seating 12a so as to allow it to be held axially on the blade 151. It should be noted that, alternatively or additionally, the insert 15 may have or comprise any other shape fulfilling the function of a guide element, for instance a projection.

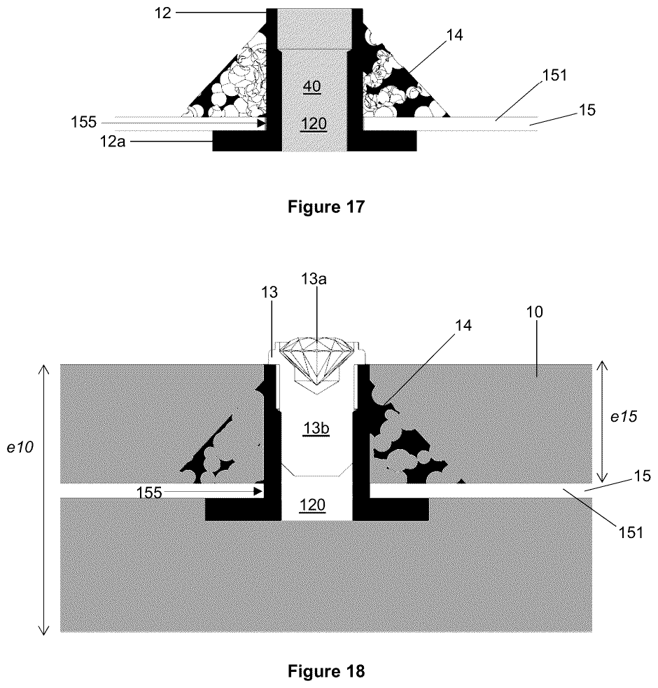

FIGS. 16 and 17 schematically illustrate the manufacturing process steps according to this third embodiment.

During the first step represented by FIG. 16, the fastening element 12 is assembled on an insert 15, which is in the form of a blade 151, as in the second embodiment. In this embodiment, the fastening element 12 is threaded through an aperture 155 from a lower face of the blade 151, and a hooking element 14 is then set into the fastening element 12 from the opposite upper face, notably by engagement around the outer surface of the fastening element 12.

The first step also includes a further sub-step, represented by FIG. 17, which is performed before the second step of filling the mould with the material 11 of the bracelet strand. This sub-step consists in closing the aperture 120 of the fastening element 12 with a filling material. For example, this filling material may be a two-component silicone containing vinyl, silicic acid and aggregating materials, which has the advantage of polymerizing in a few minutes. For example, this material may be the product known under the trade name Plastiform™ F50 or Plastiform™ F85. The filling material is, for example, deposited by means of a metering gun, and is then immediately cured so as to form an obstacle 40 to any re-entry of material 11 during the second step within the aperture 120 of the fastening element 12.

After removal from the mould, the process comprises an intermediate step of removing the obstacle 40 formed by the filling material deposited in the aperture 120 of the fastening element 12, to free this aperture 120.

The other steps of the process remain identical to those described with reference to the second embodiment.

FIG. 18 illustrates, by way of example, a first implementation variant for the bracelet strand obtained via the process according to this third embodiment, in which the blade 151 forming the insert 15 is located substantially in the middle of the thickness of the bracelet strand. In a second variant, not shown, this blade might be positioned closer to the upper surface of the bracelet strand, as described in the context of the process according to the second embodiment for obtaining a bracelet strand according to the second variant. It should be noted that such a second strand variant also has the advantage of minimizing the size of the hooking element 14, in addition to simplifying the fastening element 12. In these embodiments, the resulting fastening element 12 is set into the insert 15.

In all embodiments, the fastening element 12 may be manufactured from any material that can withstand the temperatures associated with the process. Advantageously, this material is more particularly suitable for enabling the ornamental element 13 to be engaged. By way of example, this material may be a metal alloy such as a copper alloy such as brass or CuBe₂, or even a stainless steel.

In the implementation variants described previously, the fastening elements are intended to receive ornamental elements. They may of course be intended to receive any other element, for example in order to fulfil a new function. For example, in a particular bracelet construction comprising a pin buckle, the apertures of the fastening elements could form a series of aligned apertures, intended to receive the pin and thus participate in adjusting the length of the bracelet. Such a construction would have the advantage of eliminating any deformation of these apertures intended to receive the pin, which are usually formed directly on the bracelet strand by cutting the material. A fastening element according to the invention may thus fulfil various functions, and there is therefore not necessarily a permanent fixing of a different element in a fastening element.

Moreover, as described previously, in all the implementation variants, a fastening element may be in the form of a ring, optionally comprising a seating. Such a seating has the advantage of locally limiting the bending of the strap strand around the fastening element. Needless to say, the invention is not limited to the form of the fastening elements as represented, which may take any other form depending on the functionality required. For example, a fastening element may be in the form of a cylindrical or frustoconical ring or any other shape, arranged around an axis, for example of annular shape in cross-section to said axis. Preferentially, in all the implementation variants, the fastening element, in particular the ring acting as a fastening element, comprises a surface which is flush with the upper surface of the timepiece component.

In the embodiments described, a fastening element is positioned in a mould by means of at least one guide element. Such a guide element may be in various forms. For example, it may be an element projecting in a certain direction into a cavity of the manufacturing mould, notably arranged symmetrically around an axis parallel to said direction, notably cylindrical or frustoconical in shape and/or circular in cross-section to said axis. In addition or alternatively, the at least one guide element may be in the form of a magnetic element allowing a fastening element to be positioned. In this specific case, such a guide element is not necessarily in the form of an element projecting into a mould cavity.

According to a particular implementation variant of a bracelet strand comprising an insert, it may naturally be conceivable that at least one fastening element be arranged and/or positioned independently of said insert, for example by means of at least one guide element included in the manufacturing mould. In other words, it is possible to obtain a variant of a strand comprising an insert by at least partially performing the process according to the first mode.

Furthermore, in all the implementation variants, the fastening element may or may not be combined with a hooking element, the latter being provided to maximize the anchoring of the material constituting the envelope of the component around the fastening element. Preferentially, a hooking element may be made of aluminium or titanium foam.

As described previously, an ornamental element may be in the form of an assembly such as a stone set within a bezel. The stone may, for example, be a natural stone such as a precious stone (diamond, ruby, sapphire, emerald) or a fine stone, for instance jasper. The stone may also be organic, and may, for example, be in the form of a pearl or mother-of-pearl. The bezel may, for example, be manufactured from a precious alloy such as a gold-based alloy.

Alternatively, the ornamental element may be made in one piece. For example, it may be manufactured from a ceramic, for example a ceramic mainly or predominantly composed of zirconia, or alumina, or silicon nitride, or boron carbide, or aluminium nitride. Alternatively, the ornamental element may also be made of a composite material such as an alumina-zirconia ZTA/ATZ composite. Alternatively also, the ornamental element may be made of a precious metal alloy such as a gold or platinum based alloy. Moreover, it may comprise a pattern.

In the case where an insert is used, which notably fulfils a reinforcing function, this insert has been described as being in the form of a blade. Naturally, such a blade may occupy different surfaces, extend substantially continuously over a significant dimension of a bracelet strand, for example over at least 50% or even 70% of its length, or, as a variant, take on a restricted dimension, being located solely at the fastening element(s). Furthermore, the invention is not limited to a blade-shaped insert.

Finally, the invention has been described in the context of a bracelet strand. However, it may be applied to any timepiece component which may be at least partly made of a material that is suitable for moulding as described. For example, the timepiece component might be a bezel or a bezel disc attached to a bezel ring. The ornamental elements might thus, for example, include indexes.

The invention also relates directly to a bracelet strand, or more generally a timepiece component, comprising a fastening element overmoulded with a material, as described. Optionally, the timepiece component comprises an insert or reinforcement, also overmoulded with said material.

The invention also relates to a timepiece, notably a wristwatch, comprising such a bracelet strand, or more generally such a timepiece component.

1. A process for manufacturing a timepiece component comprising at least one fastening element, the method comprising:
positioning the at least one fastening element within a manufacturing mould using at least one guide element;
filling the manufacturing mould with a material so as to overmould by at least partially enveloping and setting the at least one fastening element in the material;
removing the timepiece component from the manufacturing mould, the timepiece component being at least partly formed by the material and the at least one fastening element.

2. The process according to claim 1, wherein the manufacturing mould comprises at least two complementary half-moulds delimiting a cavity having a shape that corresponds or substantially corresponds to a shape of the timepiece component to be manufactured, and wherein:
at least one of the half-moulds comprises the at least one guide element to allow the positioning of the at least one fastening element within the cavity of the manufacturing mould; and/or
at least one independent component of the half-moulds and of the timepiece component is added to the manufacturing mould, the independent component comprising the at least one guide element to allow the positioning of the at least one fastening element within the cavity of the manufacturing mould; and/or
at least one insert of the timepiece component to be manufactured is positioned within the cavity of the manufacturing mould, the insert comprising the at least one guide element to allow the positioning of the at least one fastening element within the cavity of the manufacturing mould, the at least one guide element belonging to the insert and having a shape of a projection or of an aperture in the insert.

3. The process according to claim 1,
wherein the at least one guide element is an element projecting in one direction into a cavity of the manufacturing mould, and
wherein the at least one fastening element extends around the at least one guide element.

4. The process according to claim 1, wherein the at least one fastening element is positioned within the cavity of the manufacturing mould and extends over the entire height of this cavity from a first half-mould to a second different half-mould.

5. The process according to claim 1, comprising
an intermediate texturing and/or adding a binding primer to a surface of the at least one fastening element intended to receive the overmoulding of the material; and/or
an intermediate adding a hooking element arranged at least partially around the at least one fastening element.

6. The process according to claim 1, wherein the filling of the manufacturing mould with a material includes pressure injection of the material into a cavity of the manufacturing mould, or compression moulding of a blank of the material.

7. The process according to claim 1, comprising setting an ornamental element into the at least one fastening element.

8. A timepiece component comprising at least one fastening element, wherein the timepiece component is comprises an overmoulded material at least partially enveloping and setting the at least one fastening element within the timepiece component.

9. The timepiece component according to claim 8, wherein
the at least one fastening element has a shape of a ring of cylindrical or frustoconical shape; and/or
the at least one fastening element has an annular cross-sectional shape; and/or
the at least one fastening element has a shape of a seating ring.

10. The timepiece component according to claim 8, wherein the at least one fastening element extends over the entire height or thickness of the timepiece component.

11. The timepiece component according to claim 8, comprising at least one insert on which the at least one fastening element rests or is set.

12. The timepiece component according to claim 8, wherein
the at least one fastening element comprises a textured surface and/or a surface comprising a binding primer on which the material is overmoulded; and/or
the at least one fastening element comprises a hooking element arranged at least partially around the fastening element.

13. The timepiece component according to claim 8, wherein
the material is a thermoplastic or thermosetting polymer or an elastomer or elastomer-based material; and/or
the at least one fastening element is made of metal or of metal alloy.

14. The timepiece component according to claim 8, comprising
an ornamental element set into the at least one fastening element; and/or
several fastening elements forming fastening portions of a bracelet strand.

15. A timepiece comprising the at least one timepiece component according to claim 8.

16. The timepiece according to claim 15, which is a wristwatch.

17. The timepiece component according to claim 8, which is a bracelet strand.

18. The timepiece component according to claim 8, wherein the at least one fastening element extends over only part of a height or thickness of the timepiece component.

19. The timepiece component according to claim 11, wherein the at least one fastening element rests or is set around a projection or in an aperture of the insert or on a surface of the insert.

20. The timepiece component according to claim 12, wherein the at least one fastening element comprises the hooking element arranged at least partially around the fastening element, wherein the hooking element has a honeycomb structure in which the material is inserted.
